(19) United States
(12) Patent Application Publication
(10) Pub. No.: US 2014/0252913 A1
(43) Pub. Date: Sep. 11, 2014

(54) SINGLE PHASE SWITCHED RELUCTANCE MACHINE WITH AXIAL FLUX PATH

(71) Applicant: Everette Energy, LLC, Dallas, TX (US)

(72) Inventor: Babak Fahimi, Arlington, TX (US)

(73) Assignee: EVERETTE ENERGY, LLC, Dallas, TX (US)

(21) Appl. No.: 14/201,677

(22) Filed: Mar. 7, 2014

Related U.S. Application Data
(60) Provisional application No. 61/774,755, filed on Mar. 8, 2013.

(51) Int. Cl. H02K 1/24; H02P 6/00

(52) U.S. Cl. CPC H02K 1/246; H02P 6/00
USPC 310/216.075; 318/701

(57) ABSTRACT

A reluctance machine includes a stator plate supporting stator poles circumferentially distributed about a first central opening and a rotor plate supporting stator poles circumferentially distributed about a second central opening. A rotation shaft is mounted to the rotor plate in the second central opening, the shaft passes through the first central opening to define an axis of rotation. The rotor and stator poles extend perpendicular from the rotor and stator plates, respectively, and support flux paths during single phase actuation which include a first flux portion passing through each stator pole parallel to the axis of rotation and a second portion passing through each rotor pole parallel to the axis of rotation. The flux paths cross an air gap between the stator and rotor poles from the first portion to the second portion.

### PRIORITY CLAIM

This application claims priority from U.S. Provisional Application for Patent No. 61/774,755 filed Mar. 8, 2013, the disclosure of which is incorporated by reference.

### TECHNICAL FIELD

This application relates to switched reluctance machines.

### BACKGROUND

Reluctance machines are well known in the art. These machines operate on the tendency of the machine's rotor to move to a position where the reluctance with respect to the excited stator pole is minimized (in other words, where the inductance is maximized). This position of minimized reluctance occurs where the rotor pole is aligned with an energized stator pole. When operated as a motor, energizing the stator pole generates a magnetic field attracting the closest rotor pole towards the stator pole. This magnetic attraction produces a torque causing the rotor to rotate and move towards the minimized reluctance position. Conversely, when operated as a generator, torque applied to the rotor is converted to electricity as the rotor pole moves away from the aligned position with respect to an energized stator pole.

### SUMMARY

In an embodiment, a reluctance machine comprises: a stator plate including a central opening; a plurality of stator poles, circumferentially distributed about the central opening of the stator plate, that extend perpendicular from the stator plate; a rotor plate including a central opening; a plurality of rotor poles, equal in number to the plurality of stator poles and circumferentially distributed about the central opening of the rotor plate, that extend perpendicular from the rotor plate; wherein a stator pole top surface faces a rotor pole top surface; and a shaft mounted to the rotor plate at the central opening of the rotor plate and passing through the central opening of the stator plate.

In an embodiment, a reluctance machine comprises: a stator plate including a central through opening and a plurality of circumferentially distributed first blind openings; a plurality of stator poles, each stator pole inserted into and mounted within one first blind opening, the stator poles extending parallel to an axis of rotation for the machine; a rotor plate including a central through opening and a plurality of circumferentially distributed second blind openings; a plurality of rotor poles, equal in number to the plurality of stator poles, each rotor pole inserted into and mounted within one second blind opening, the rotor poles extending parallel to said axis of rotation for the machine; wherein a stator pole top surface faces a rotor pole top surface; and a shaft mounted to the rotor plate at the central through opening of the rotor plate and passing through the central through opening of the stator plate.

In an embodiment, a method for exciting a switched reluctance machine comprises energizing a plurality of stator poles in a single excitation phase to generate flux paths including a first portion passing through each stator pole parallel to an axis of rotation for a rotor of said machine having a corresponding plurality of rotor poles, said flux paths further including a second portion passing through each rotor pole parallel to the axis of rotation and crossing an air gap between the stator and rotor poles from the first portion to the second portion.

### BRIEF DESCRIPTION OF THE DRAWINGS

A more complete understanding of the invention may be obtained by reference to following detailed description in conjunction with the drawings wherein:

FIG. 1 illustrates a perspective view of a switched reluctance machine;

FIG. 2 illustrates a cross-sectional view of the machine of FIG. 1;

FIG. 3 illustrates a rotor pole for the machine of FIG. 1;

FIG. 4 illustrates a rotor plate for the machine of FIG. 1;

FIG. 5 illustrates a stator pole for the machine of FIG. 1;

FIG. 6 illustrates a stator plate for the machine of FIG. 1;

FIG. 7 illustrates a bobbin for the machine of FIG. 1;

FIG. 8 illustrates bobbin winding for the machine of FIG. 1;

FIG. 9 illustrates a circuit diagram for the phase winding;

FIG. 10 illustrates the flux path;

FIG. 11 illustrates a block diagram of a circuit for a switched reluctance machine;

FIGS. 12A-12C illustrate drive circuitry and operation;

FIG. 12D illustrates an alternative drive circuit;

FIGS. 13A and 13B illustrate flux density;

FIG. 14 illustrates the torque profile;

FIG. 15 illustrates a stacked switched reluctance machine configuration utilizing multiple machines of the type shown in FIG. 1; and

FIG. 16 illustrates a stacked switched reluctance machine configuration utilizing multiple machines of the type shown in FIG. 1.

### DETAILED DESCRIPTION OF THE DRAWINGS

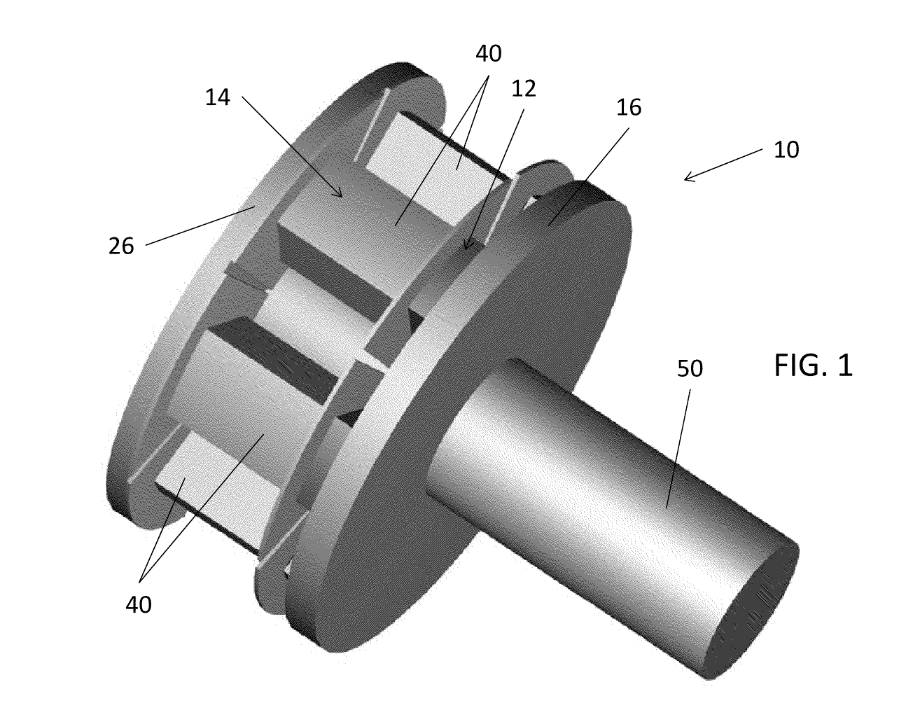

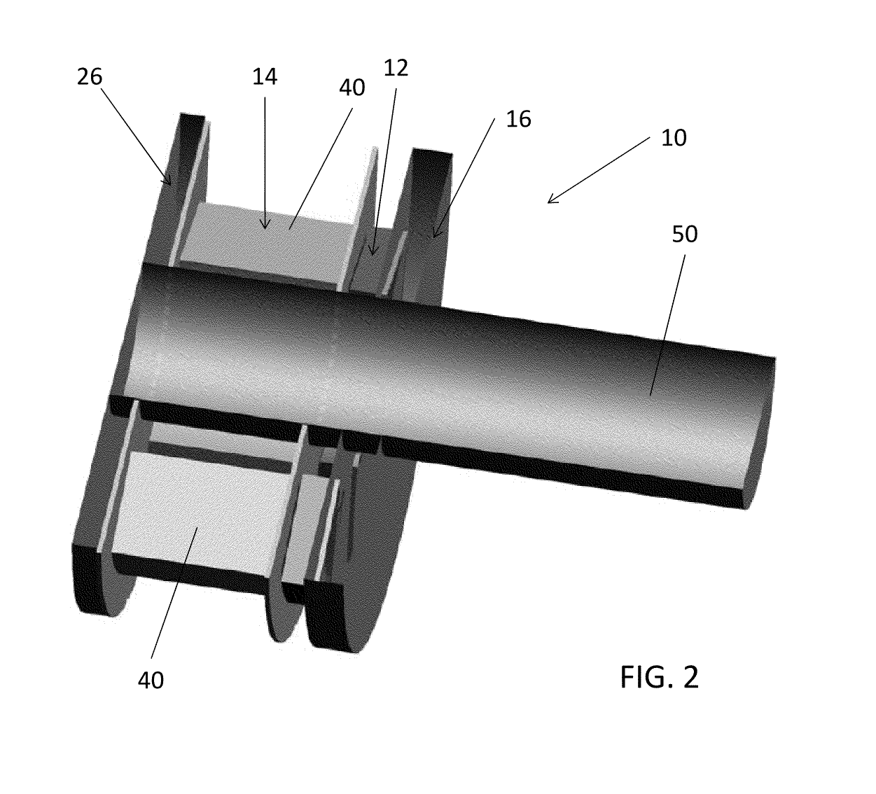

Reference is now made to FIGS. 1 and 2 which illustrate (in perspective and cross-sectional perspective views, respectively) a single phase switched reluctance machine 10 having a 6/6 topology. The reference to “6/6” indicates that the machine 10 has six rotor poles 12 and six stator poles 14. The reference to “single-phase” indicates that there is only one stator energizing phase, and thus each of the six windings (not explicitly shown) on the stator are energized simultaneously. Higher numbers of stator poles than six can be used provided the same number of rotor poles are included. As few as four poles can be used. Selection of the number of included poles depends on the application to which the machine intends to be used.

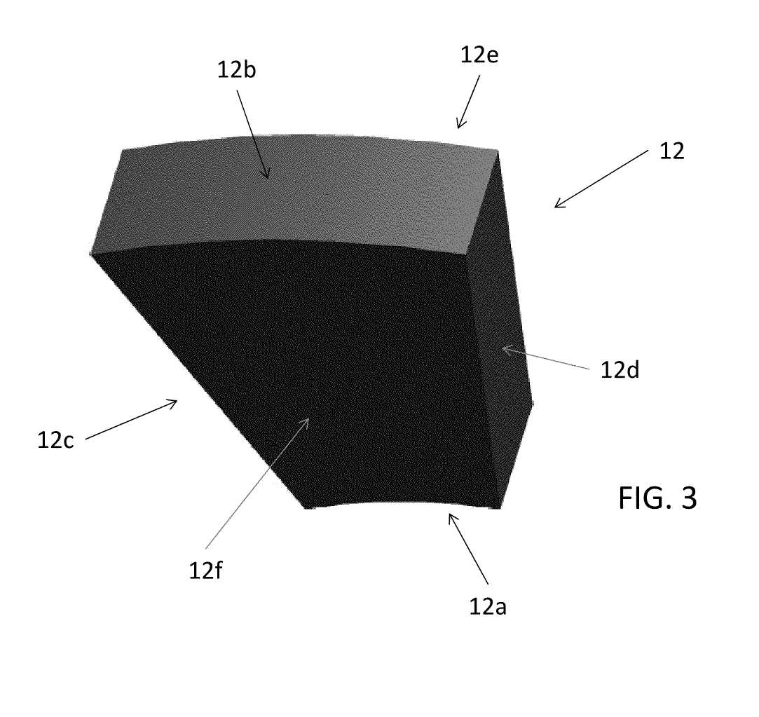

A rotor pole 12 is shown in FIG. 3. The rotor pole 12 has a wedge shaped cross section with a first circumferential surface 12a, a second circumferential surface 12b, a first radial surface 12c and a second radial surface 12d. The rotor pole 12 further includes a top surface 12e and a bottom surface 12f.

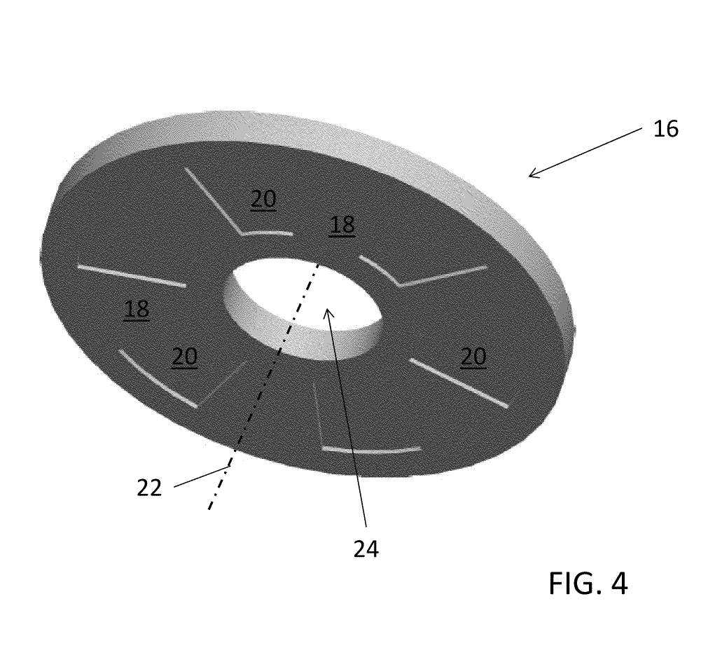

The bottom surfaces 12f of the rotor poles 12 are mounted to a rotor plate 16 as shown in FIG. 4. A front surface 18 of the rotor plate 16 includes a plurality of recessed openings 20 circumferentially spaced about a center axis 22 of the rotor plate 16. The surface 18 is in a plane which extends perpendicular to an axis of rotation for the machine 10. The recessed openings 20 are formed as blind openings with a wedge cross-sectional size and shape substantially conforming to the wedge cross-sectional size and shape of the rotor pole 12 (see, FIG. 3). This configuration permits each rotor pole 12 to be seated in a corresponding recessed opening 20. The rotor poles 12 may be secured in the recessed openings 20 through any suitable means. The rotor poles accordingly extend perpendicular from the plate 16 and surface 18.

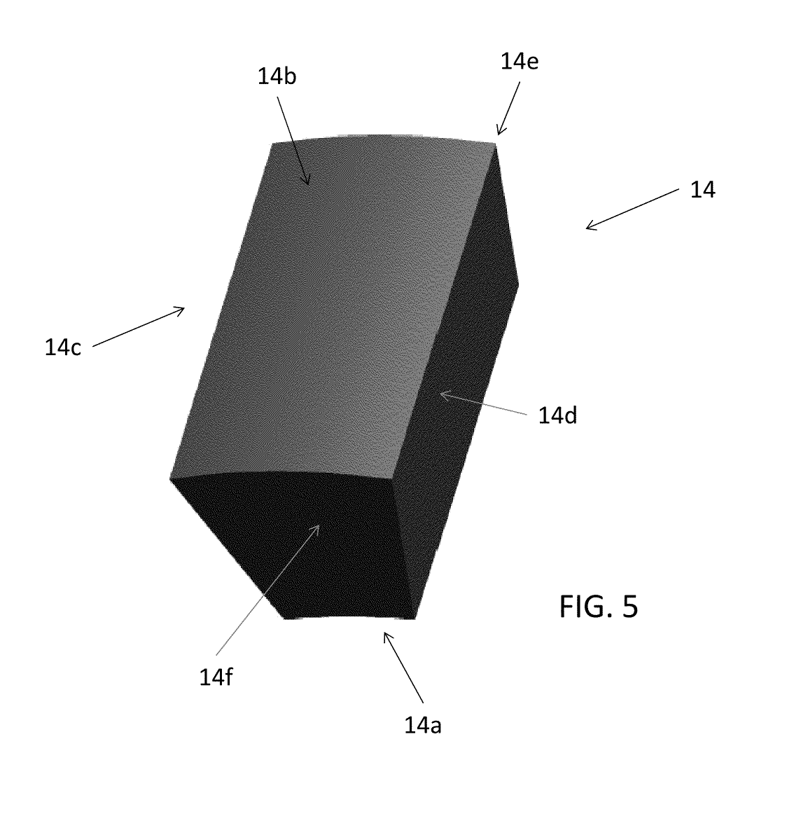

A stator pole 14 is shown in FIG. 5. The stator pole 14 has a wedge shaped cross section with a first circumferential surface 14a, a second circumferential surface 14b, a first radial surface 14c and a second radial surface 14d. The stator pole 14 further includes a top surface 14e and a bottom surface 14f.

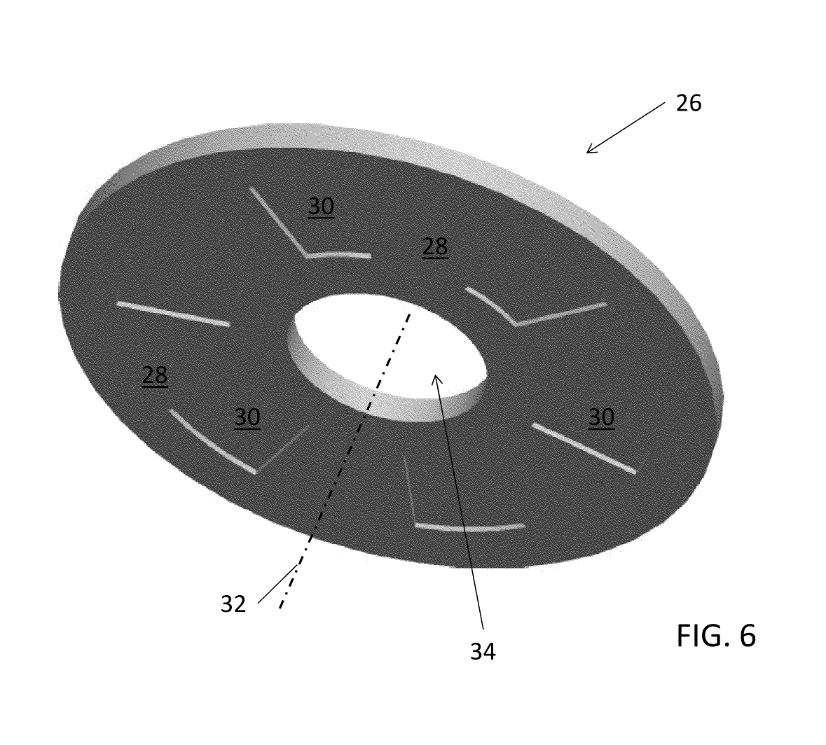

The bottom surfaces 14f of the stator poles 14 are mounted to a stator plate 26 as shown in FIG. 6. A front surface 28 of the stator plate 26 includes a plurality of recessed openings 30 circumferentially spaced about a center axis 32 of the stator plate 26. The surface 28 is in a plane which extends perpendicular to an axis of rotation for the machine 10. The recessed openings 30 are formed as blind openings with a wedge cross-sectional size and shape substantially conforming to the wedge cross-sectional size and shape of the stator pole 14 (see, FIG. 5). This configuration permits each stator pole 14 to be seated in a corresponding recessed opening 30. The stator poles 14 may be secured in the recessed openings 30 through any suitable means. The stator poles accordingly extend perpendicular from the plate 26 and surface 18.

Reference is once again made to FIGS. 1 and 2. A bobbin 40 is installed on each stator pole 14.

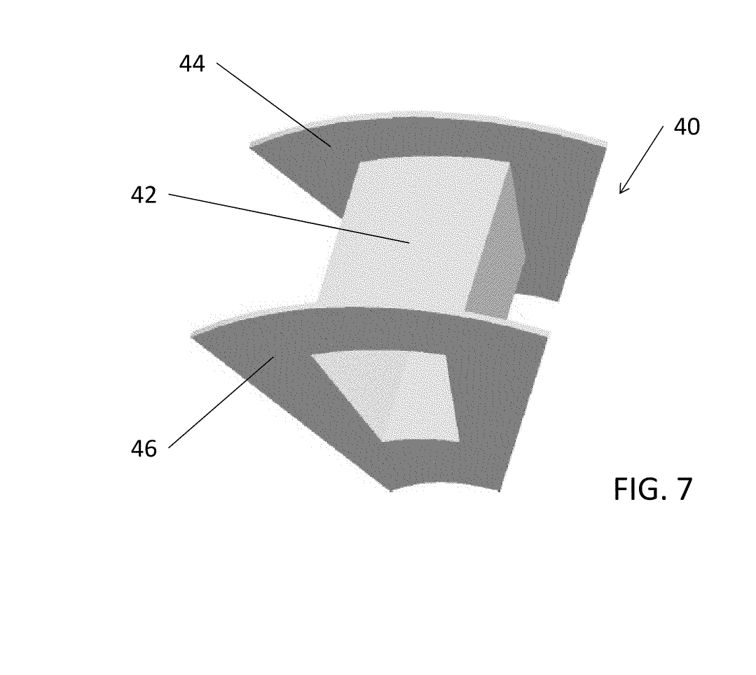

A perspective view of the bobbin 40 is shown in FIG. 7. The bobbin 40 includes a central hollow core 42, and end members 44 and 46. The central hollow core 42 is sized and shaped to slip over the stator pole 14.

Illustration of the windings for the bobbins 40 is omitted in FIGS. 1, 2 and 7 so as to not obscure the structural features of the machine 10.

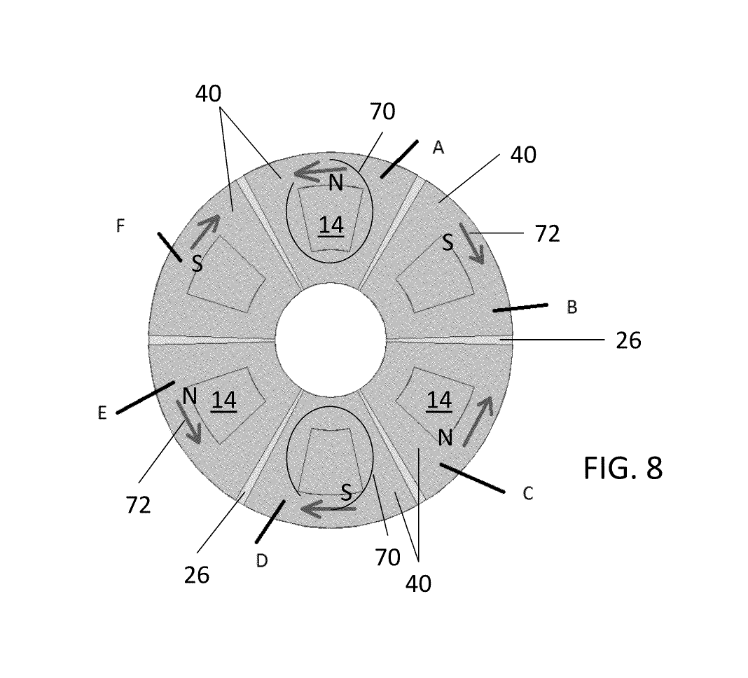

With reference to FIG. 8, which illustrates an end view of a collection of bobbins associated with stator poles, each bobbin 40 supports a corresponding winding 70 with a winding direction 72 (corresponding to current flow direction). A single turn of the winding 70 on two of the bobbins is illustrated, but it will be understood that each winding on each of the bobbins is formed of a plurality of turns. It will further be understood that each winding 70 may in fact be formed of a plurality of separate windings coupled in parallel.

It will be noted that the winding directions 72 alternate orientation about the circumference of the stator plate 26. The effect of this alternating direction for winding of the coils 70 is to ensure alternating . . . N/S/N/S . . . magnetic orientations of the stator poles 14 about the circumference of the stator plate 26. This solution requires only a single power converter (drive) circuit for each machine 10.

The alternating orientation can also be accomplished by altering the direction of current in adjacent poles (in which case, reference 72 specifically refers only to the direction of current flow). This solution requires individual power converter (drive) circuits for excitation of each stator pole of the machine 10.

It will accordingly be noted that in the gap between circumferentially adjacent stator poles, the direction of current flow from the two adjacent stator windings 70 is in a same radial direction.

The windings are identified with labels “A”-“F”. The windings A, C and E are wound in a first winding direction to provide north magnetic poles (N) while the windings B, D and F are wound in a second winding direction to provide south magnetic poles (S).

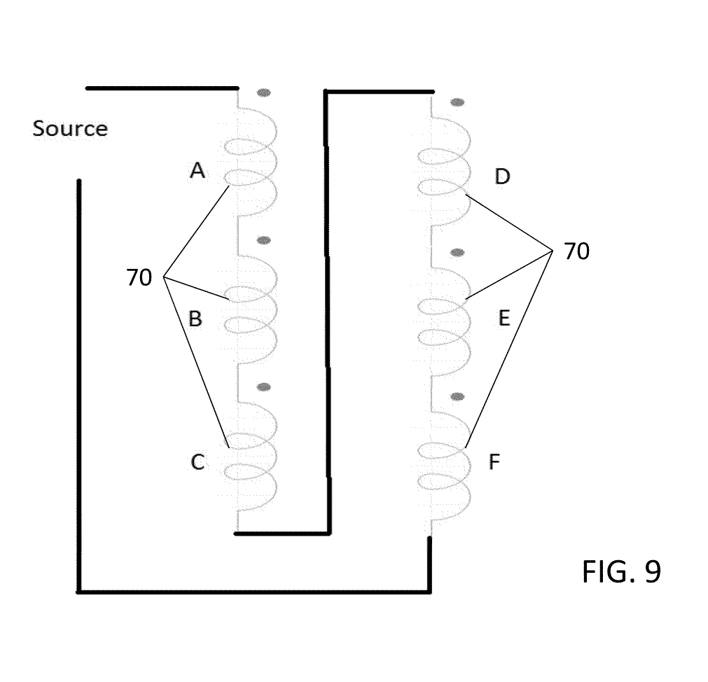

The windings 70 may be connected in series as shown in FIG. 9 and are simultaneously excited (in a single actuation or excitation phase) by the current drive source. Although FIG. 9 illustrates the series connection of windings 70, it will be understood that windings 70 could alternatively be connected in parallel.

Although providing alternating winding directions with respect to the windings 70 of the stator poles 14 is a preferred implementation, it will be understood that alternate configurations with a common winding direction for all stators with alternately oriented current excitations could alternately be used so as to provide alternating . . . N/S/N/S . . . magnetic orientations about the circumference of the stator plate 26 during single phase excitation of the machine 10.

Reference is once again made to FIGS. 1, 2 and 4. A shaft 50 is mounted within the central opening 24 of the rotor plate 16. The shaft 50 is coupled to the rotor plate 16 at the central opening 24 such that rotation of the rotor plate about the axis 22 causes a corresponding rotation of the shaft 50.

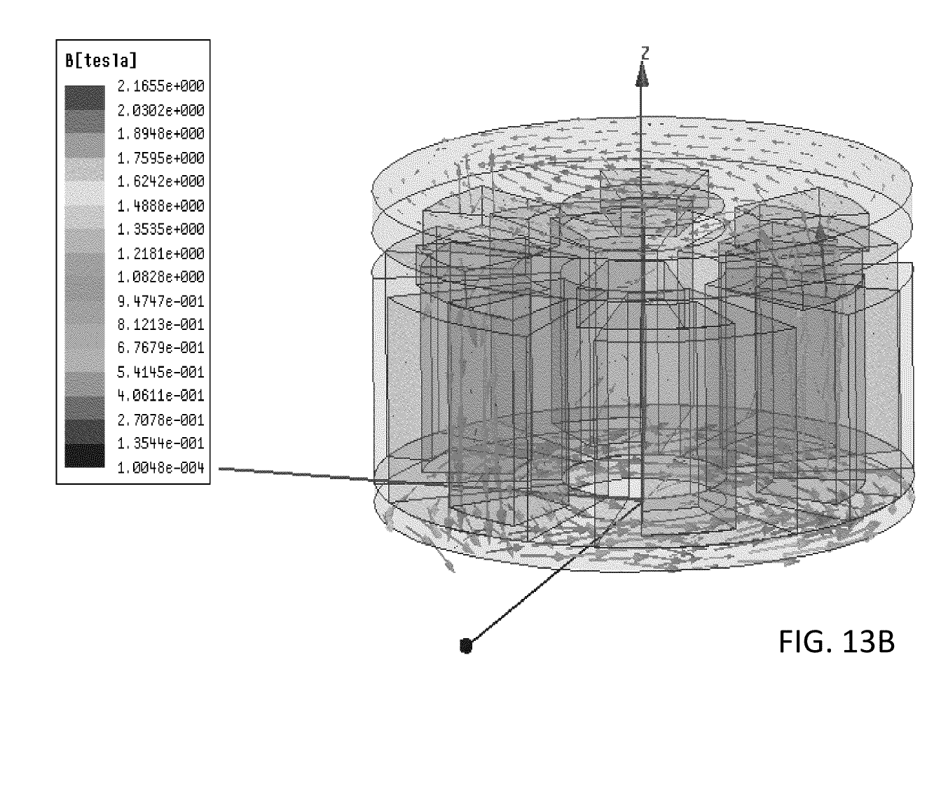

With additional reference now to FIG. 6, the shaft 50 is supported for rotation by the central opening 34 of the stator plate 26. The central opening 34 may form a rotational bearing for the shaft 50 (or the shaft ends may be supported for rotation by other structure (see, for example, FIG. 14). Although a reduced friction bearing mechanism, such as roller bearings or other journal bearings, are not illustrated in FIGS. 1, 2 and 6, it will be understood by those skilled in the art that any suitable reduced friction bearing mechanism could be installed in the central opening 34 and configured to support rotation of the shaft about the axis 32 (which is aligned with the axis 22).

It will be understood that the illustrated 6/6 topology is exemplary only and that the single phase switched reluctance machine 10 may have any desired even number of poles. In other words, the single phase switched reluctance machine 10 may have an M/M topology, where M is an even integer (M being preferably greater than or equal to 4, and more particularly greater than or equal to 6, and including M=8 or M=10).

FIGS. 1 and 2 illustrate the rotor pole 12 and stator pole 14 at a rotational position of minimum reluctance (or maximum inductance). The air gap between the top surface 12e of the rotor pole 12 and the top surface 14e of the stator pole 14 is preferably kept to a minimal value.

The rotor pole 12 and stator pole 14 may be constructed of a unitary solid metal body for low speed applications. Alternatively, the rotor pole 12 and stator pole 14 may be constructed of a plurality of laminations.

The rotor plate 16 and stator plate 26 may be constructed of a unitary solid metal body. Alternatively, the rotor plate 16 and stator plate 26 may be constructed of a plurality of laminations.

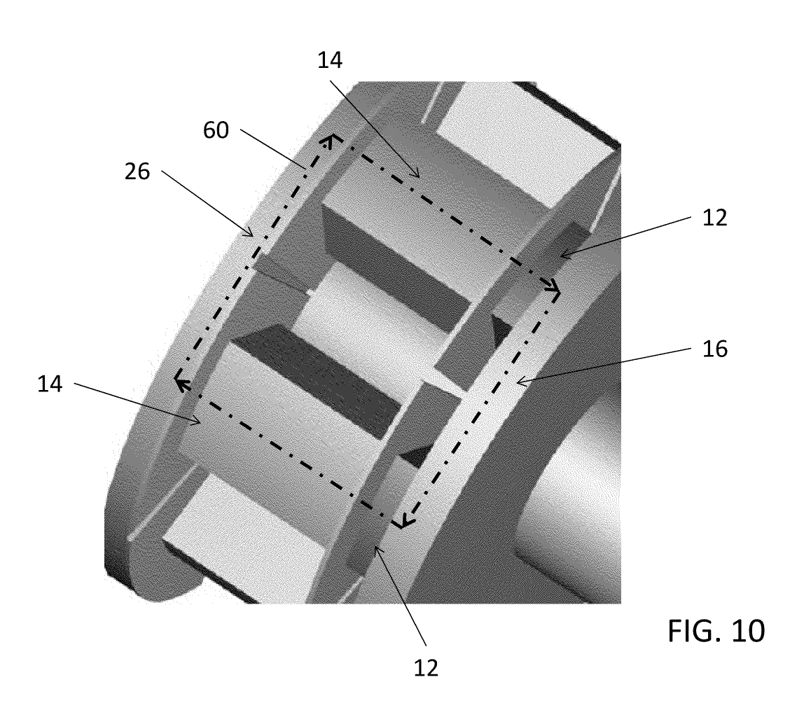

Whatever construction is selected for the rotor pole 12, rotor plate 16, stator pole 14 and stator plate 26, the selected construction should be configured to permit the passage of a magnetic flux path 60 as shown in FIG. 10. The single phase switched reluctance machine 10 is accordingly a two air gap machine and the flux path 60 travels axially along a first rotor pole 12, crosses a first air gap to a first stator pole 14, continues to travel axially through the first stator pole 14, then travels through the stator plate 26 to a second stator pole 14 (circumferentially adjacent to the first stator pole), travels axially along the second stator pole 14, crosses a second air gap to a second rotor pole 12, continues to travel axially through the second rotor pole, and travels through the rotor plate 16 back to the first rotor pole 12.

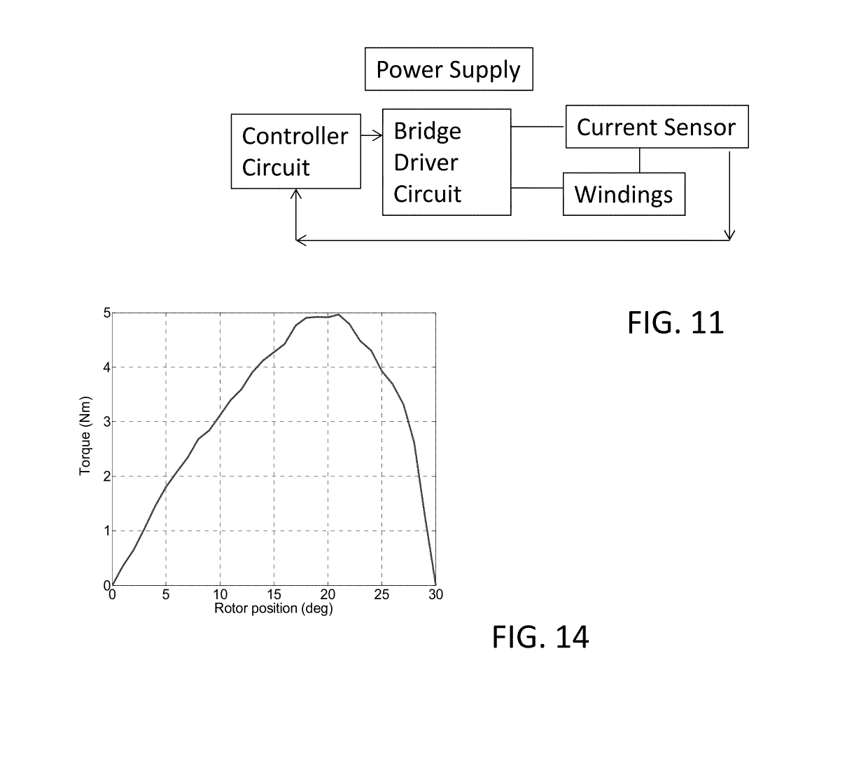

Reference is now made to FIG. 11. The control circuitry for the machine 10 is of conventional design known to those skilled in the art. The controller circuit may, for example, comprise a digital signal processor (DSP) programmed to implement drive control. A bridge driver circuit is provided to drive the machine windings. The bridge driver circuit may comprise an asymmetric-bridge or full bridge configuration. The driver transistors within the bridge driver circuit receive gate control signals output from the controller circuit DSP. A current sensor is coupled to the motor windings to sense current passing through the machine windings and provide the sensed current information to the controller circuit DSP. The sensed current information is evaluated during the motoring phase of operation and used to determine when to actuate the driver transistors within the bridge driver circuit. A hysteresis control algorithm may be used during the motoring phase. An idle phase will be used for detection of the commutation instants. This is accomplished by energizing the idle phase of the stator with a series of high frequency voltage pulses. The main converter is used for this purpose. By precise monitoring of the diagnostic current, one can detect the commutation instant for the motoring mode of operation. It is important to note that the magnitude of the sensed diagnostic current depends inversely on the inductance and thereby introducing a one-on-one corresponding between the rotor position and the magnitude of the diagnostic current.

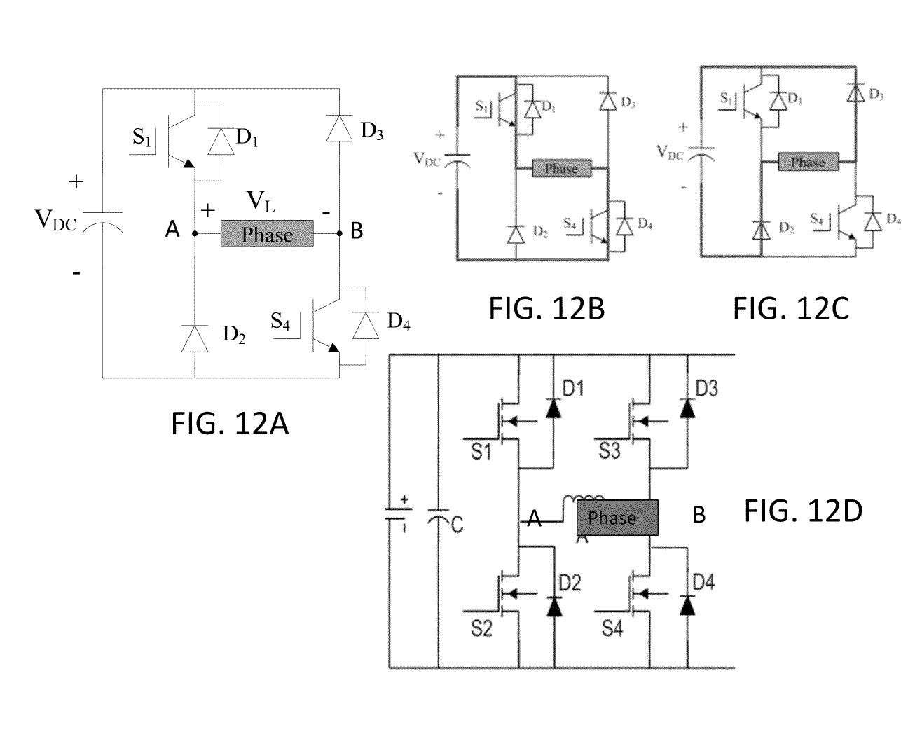

The bridge driver circuit may comprise an asymmetric-bridge (FIGS. 12A-12C) or full bridge (FIG. 12D) coupled to all the windings 70 of the machine (see, “source” reference in FIG. 9). Alternatively, separate asymmetric-bridge or full bridge circuits could be used for each winding 70, or correspondingly magnetically oriented set of windings 70.

The machine as shown in FIGS. 1-2, when configured as a motor, is not self-starting because the rotor could stop rotating at a position where the rotor poles were aligned with the stator poles (the minimized reluctance position). To address this issue, the machine of FIGS. 1-2 could further include a parking magnet which attracts the rotor poles to a position offset from the stator poles and from which starting is possible. Alternatively, the rotor poles could be shaped with a configuration that permits self-starting from any rotor position including when aligned with the stator poles. Parking magnet and self-starting rotor pole shape solutions are well known to those skilled in the art.

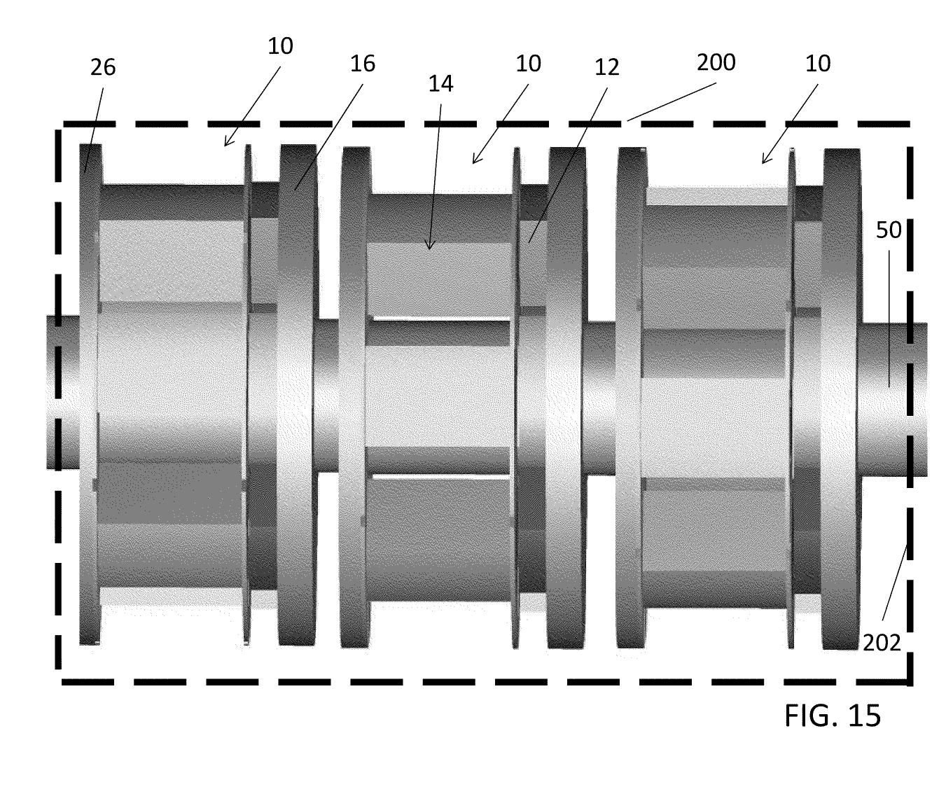

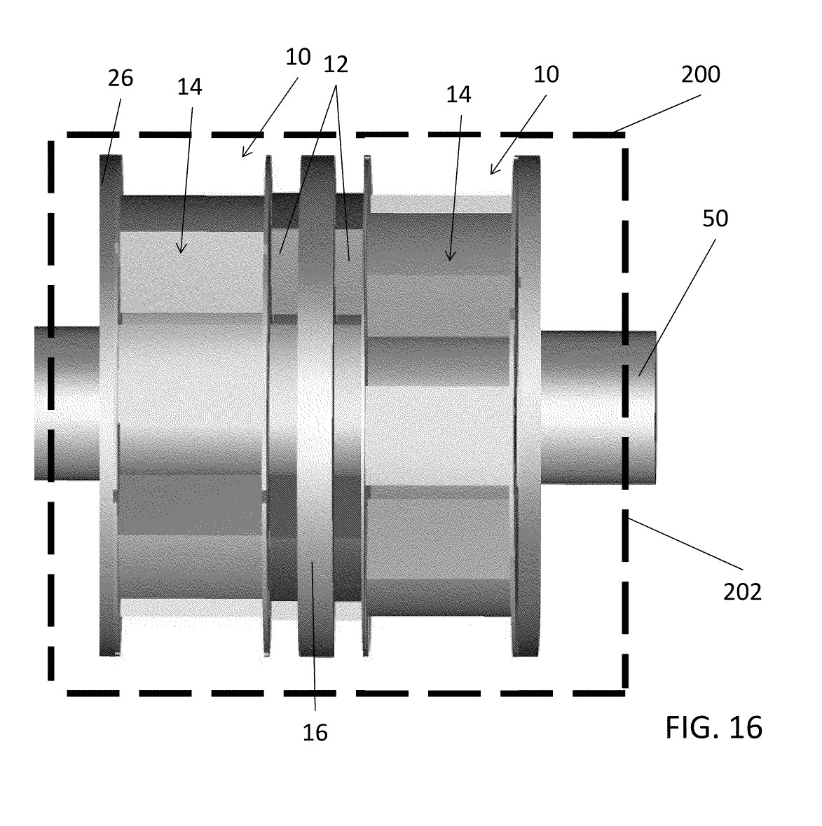

In a further embodiment, multiple switched reluctance machines (one such machine 10 as is shown in FIGS. 1-2) can be stacked on a common shaft 50 as shown in FIGS. 15 and 16. Any suitable means (generally indicated by enclosure 200) may be used to support the stator plates 26 of the included machines 10. Shaft end support structures 202, including suitable bearings (not explicitly shown), may be provided to support the opposite ends of the shaft 50. By angularly offsetting the multiple machines from each other, the stacked machine presents a motor configuration that is self-starting because the rotor poles of at least one of the machines will be sufficiently offset from the stator poles to allow for magnetic attraction and torque generation. For example, the angular offset could be introduced by angularly offsetting the stator poles and keeping the rotor poles in alignment (as is shown in FIG. 15). Alternatively, the angular offset could be introduced by angularly offsetting the rotor poles and keeping the stator poles in alignment. An angular offset of 360/(M*N) degrees between each of the included machines is acceptable (when M is the number of machines in the stack). In a preferred implementation, the angular offset may, for example, comprise 10-25 degrees.

FIGS. 15 and 16 differ in the number of included machines 10 (odd number equal to three, for example, in FIG. 15 and even number equal to two, for example, in FIG. 16). It will be understood, however, that the illustration of a two-stack and a three-stack is exemplary only. FIG. 16 differs from FIG. 15 in that the rotor plate 16 is a shared plate for two machines 10, with rotor poles (FIG. 3) provided on both sides of the plate 16 (FIG. 4). In this configuration, the stators are oriented to face the shared rotor plate.

The bridge driver circuitry will preferably comprise a separate bridge driver circuit(s) for each machine in the stack so as to exercise separate phase control over the operation of each individual machine.

In a preferred implementation, a machine is provided having a three-stack axial flux switched reluctance machine design like that shown in FIG. 15. In an exemplary implementation, the machine current density is 5 A/mm² and the filling factor is considered as 0.65. Each stator stack should be shifted by 15 mechanical degrees. Each stack has 6 stator poles and 6 rotor poles. The machine is capable of producing continuous power of 2.1 kW at 3600 rpm.

Exemplary specifications for one stack are shown in Table 1:

| Number of turns per winding | 150 | |
|---|---|---|
| Rated phase current | 8.9 | A |
| Winding arrangement | 6 windings are in series | |
| Outer diameter | 4.5 | inch |
| Axial length of each stack | 52.5 | mm |
| Spacer between stacks | 3 | mm |
| Total length (three stacks) | 6.5 | inch |
| Rated power | 2 | Kw |
| Maximum torque | 8.0 | Nm |
| Rated speed | 3600 | rpm |

| | |
|---|---|
| Lamination material | M19G26 |

The wire for each winding 70 may comprise three windings of AWG20 wire connected in parallel (or the equivalent thereof). It is preferred to have a few smaller diameter wires forming one conductor for the purpose of reducing the resistance at high frequency due to skin effect.

The winding design may be as follows:

Here it is assumed the use of a three stack machine. To calculate the turn number of primary winding, use the following equation:

$$E \approx i {ω}_{r} \frac{d L}{d θ} \approx \frac{{ω}_{r} 8}{π} N ( {ϕ}_{a} - {ϕ}_{u} )$$

Therefore, for a base speed of 3600 rpm and a back-emf voltage limitation of 200 volt, and if there are four series windings and two parallel branches, then:

0.041≈N(φₐ−φᵤ)

By static analysis of the machine, aligned and unaligned fluxes are obtained as 0.56 mWb and 0.29 mWb, respectively. Therefore, the turn number approximately would be 150.

Using that turn number (150) and knowing a turn ampere (1330), the current in the winding 70 is 8.9 A. Considering the duty cycle of 0.5, the rms value of current is 7.8 A. Assuming current density of 5 A/mm², the cross section area becomes 1.56 mm². So, three parallel wires with gauge of 20 which have 1.556 mm² area is a good selection.

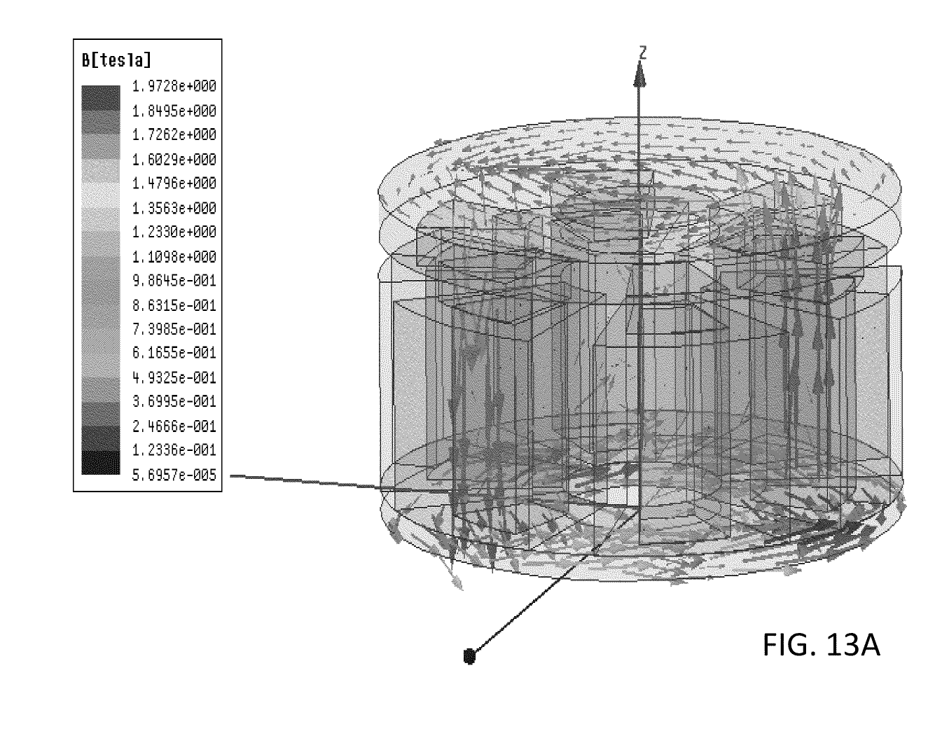

Three dimensional FEM has been employed to calculate the torque and flux of the machine 10. Only one stack of the machine is implemented in the analysis. Flux density vectors in the machine due to the excitation of two coils are depicted in FIGS. 13A and 13B.

The flux density vectors for the machine 10 due to the excitation of two coils with the rotor and stator aligned is shown in FIG. 13A. The flux density vectors for the machine 10 due to the excitation of two coils with the rotor and stator unaligned is shown in FIG. 13B. The torque profile for the machine is shown in FIG. 14.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A reluctance machine, comprising:
a stator plate including a central opening;
a plurality of stator poles, circumferentially distributed about the central opening of the stator plate, that extend perpendicular from the stator plate;
a rotor plate including a central opening;
a plurality of rotor poles, equal in number to the plurality of stator poles and circumferentially distributed about the central opening of the rotor plate, that extend perpendicular from the rotor plate;
wherein a stator pole top surface faces a rotor pole top surface; and
a shaft mounted to the rotor plate at the central opening of the rotor plate and passing through the central opening of the stator plate.

2. The machine of claim 1, wherein a flux path passes axially along the stator pole, crosses an air gap and passes axially along the rotor pole.

3. The machine of claim 2, wherein said flux path further passes through the stator plate to an adjacent stator pole.

4. The machine of claim 2, wherein said flux path further passes through the rotor plate to an adjacent rotor pole.

5. The machine of claim 1, wherein the stator and rotor support a flux path traveling in a plane parallel to the axis of rotation that crosses two air gaps provided at corresponding pairs of rotor-stator poles that are circumferentially adjacent to each other.

6. The machine of claim 5, wherein the flux path passes in an axial direction through rotor pole and stator pole of each rotor-stator pole pair.

7. The machine of claim 1, wherein each stator pole has a stator winding, and wherein current in two windings of circumferentially adjacent stator poles is controlled such that radial current flow in the two windings through a gap between the circumferentially adjacent stator poles during single phase excitation flows in a same axial direction.

8. The machine of claim 7, wherein the controlled current flow in the two windings through the gap in the same axial direction is enforced by orienting the winding on the adjacent stator poles.

9. The machine of claim 7, wherein the controlled current flow in the two windings through the gap in the same axial direction is enforced by controlling a switched direction of current applied to the windings during single phase excitation.

10. The machine of claim 1, wherein the number of stator poles is an even integer.

11. The machine of claim 1, wherein multiple machines are stacked on a common axis of rotation.

12. The machine of claim 1, wherein a stator pole bottom surface opposite the stator pole top surface is mounted to the stator plate and wherein a rotor pole bottom surface opposite the rotor pole top surface is mounted to the rotor plate.

13. The machine of claim 1, wherein the stator plate and rotor plate include surfaces which extend perpendicular to the shaft and an axis of rotation for the machine, the plurality of stator poles extending perpendicular from said surface of the stator plate and the plurality of rotor poles extending perpendicular from said surface of the rotor plate.

14. A reluctance machine, comprising:
a stator plate including a central through opening and a plurality of circumferentially distributed first blind openings;
a plurality of stator poles, each stator pole inserted into and mounted within one first blind opening, the stator poles extending parallel to an axis of rotation for the machine;
a rotor plate including a central through opening and a plurality of circumferentially distributed second blind openings;
a plurality of rotor poles, equal in number to the plurality of stator poles, each rotor pole inserted into and mounted within one second blind opening, the rotor poles extending parallel to said axis of rotation for the machine;
wherein a stator pole top surface faces a rotor pole top surface; and
a shaft mounted to the rotor plate at the central through opening of the rotor plate and passing through the central through opening of the stator plate.

15. The machine of claim 14, wherein the central through opening of the stator plate functions as a rotational support mechanism for said shaft.

16. The machine of claim 14, further comprising a stator winding around each stator pole, with the windings electrically connected to each other to form a stator phase.

17. The machine of claim 14, wherein a flux path for said machine includes a first portion passing through the stator pole parallel to the axis of rotation and a second portion passing through the rotor pole parallel to the axis of rotation and crossing an air gap between the stator pole and rotor pole from the first portion to the second portion.

18. The machine of claim 14, wherein multiple machines are stacked on said axis of rotation.

19. The machine of claim 14, wherein a stator pole bottom surface opposite the stator pole top surface is mounted to the stator plate and wherein a rotor pole bottom surface opposite the rotor pole top surface is mounted to the rotor plate.

20. The machine of claim 14, wherein the stator plate and rotor plate include surfaces which extend perpendicular to the shaft and an axis of rotation for the machine, the plurality of stator poles extending perpendicular from said surface of the stator plate and the plurality of rotor poles extending perpendicular from said surface of the rotor plate.

21. A method for exciting a switched reluctance machine, comprising energizing a plurality of stator poles in a single excitation phase to generate flux paths including a first portion passing through each stator pole parallel to an axis of rotation for a rotor of said machine having a corresponding plurality of rotor poles, said flux paths further including a second portion passing through each rotor pole parallel to the axis of rotation and crossing an air gap between the stator and rotor poles from the first portion to the second portion.
